(19) United States
(12) Patent Application Publication
(10) Pub. No.: US 2024/0099258 A1
(43) Pub. Date: Mar. 28, 2024

(54) ROOFING SYSTEM THAT HAS AN ENCAPSULATED HEATING ELEMENT WHICH RADIATES HEAT INTO PET HOUSE

(71) Applicants: HARSHA V VANGALA, Hyderabad (IN); NEELKANTH VANGALA, Hyderabad (IN)

(72) Inventors: HARSHA V VANGALA, Hyderabad (IN); NEELKANTH VANGALA, Hyderabad (IN)

(21) Appl. No.: 18/274,827

(22) PCT Filed: Apr. 16, 2021
(86) PCT No.: PCT/IB2021/053144

§ 371 Date: Jul. 28, 2023

(30) Foreign Application Priority Data
Jan. 29, 2021 (IN) 202141003979

(51) Int. Cl. A01K 1/00; A01K 1/03

(52) U.S. Cl. CPC A01K 1/0076; A01K 1/033

(57) ABSTRACT

Exemplary embodiments of the present disclosure are directed towards one or more building panels that are provided with an encapsulated heating element, embedded into the building element thus concealed and configured to emit radiant heat into the pet house, the one or more building panels are protected with a safety thermal cutout to limit the temperature of the one or more building panels. Such building panels can also be provided with a thermostat to control the temperature inside the pet house.

### TECHNICAL FIELD

The present disclosure generally relates to pet houses. More particularly the present disclosure relates to a building element in general and roofing system in particular that has an encapsulated heating element embedded into the building elements which radiates heat into a pet house.

### BACKGROUND

Conventional pet houses for dogs, cats, or similar animals have been constructed in different ways generally to satisfy the particular desires of the owner of the occupant-animal. Pet houses particularly externally located need to be heated for the comfort of the pets such as cat, dog and other similar pets. Mostly, several types of heaters are available that can be fitted in the pet houses in a carefully manner and installed in a way so as not to cause any risk to the pets either by itself or by any act of the pets. Pet houses have been built with wood, hardened plastic and different types of materials. Each type of material has its own advantages and disadvantages. It is general practice to fit heaters inside pet house to keep them warm.

### PRIOR ART

For example, U.S. Pat. No. 4,729,343 of March 1989 discloses an insulated flat bottomed insulated sleeping enclosure with collapsible Roofing arch. A typical example of a heated pet house is found in U.S. Pat. No. 5,003,923 A by Sonny D. Morgan in the year 2009 discloses a heating system mounted in a hollow interior enclosure that is with guide runner to facilitate manual removal and installation of unit. U.S. Pat. No. 3,962,993A by Donald P. Dattilo—1925 discloses a temperature-controlled ambient house that consists of two chambers in housing, one chamber is to house the pet and the other chamber is to generate heat and thermal conductor system to transfer the heat into first chamber by heat conducting means that includes a fan. None of these patents discloses a method by which a building element of the house doubling up as a heater for heating of the pet house.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Exemplary embodiments of the present disclosure are directed towards a roofing system by integrating encapsulated heating elements to radiate heat into pet house.

Another objective of the invention directed towards enabling the user to integrate the encapsulated heating element inside wall panels of the pet house or pet enclosure.

Another objective of the invention directed is towards allowing radiant heat in the pet house with utmost safety.

Another objective of the invention directed towards integrating the heating system into commonly used building material.

Another objective of the invention is directed towards embedding an encapsulated heating element that can withstand high impulse voltages as required providing a higher amount of safety for the occupants inside the pet house/pet enclosure.

According to another exemplary aspect, a roofing system integrated with a thermostat to control temperature inside a pet house/pet enclosure, comprising one or more building panels which are provided with an encapsulated heating element.

According to another exemplary aspect, the one or more building panels are protected with a safety thermal cutout to limit the temperature of the one or more building panels.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 represented as 100 is an example diagram depicting a pet house with single inclined rooftop, in accordance with one or more exemplary embodiments.

FIG. 2 represented as 200 is another example diagram depicting a pet house having two sloping roofs with a ridge piece in the center, in accordance with one or more exemplary embodiments.

FIG. 3 represented as 300 is a diagram depicting a typical construction of the encapsulated heating element that can withstand high impulse voltage when embedded between two nonmetallic sheets, in accordance with one or more exemplary embodiments.

FIG. 4 represented as 400 is a diagram depicting an exploded view of the encapsulated heating element, in accordance with one or more exemplary embodiments.

FIG. 5 represented as 500 is a diagram depicting the addition of a rigid thermal insulation on top of the heating element and a weathering sheet on the top, in accordance with one or more exemplary embodiments which is the building element with heating element inside.

FIG. 6 represented as 600 is another example diagram depicting the placement of a grid on the heating element where thermal insulation material is placed, in accordance with one or more exemplary embodiments.

FIG. 7 represented as 700 is a flow chart depicting an exemplary method to integrate heating system into building elements of the pet house, in accordance with one or more exemplary embodiments.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

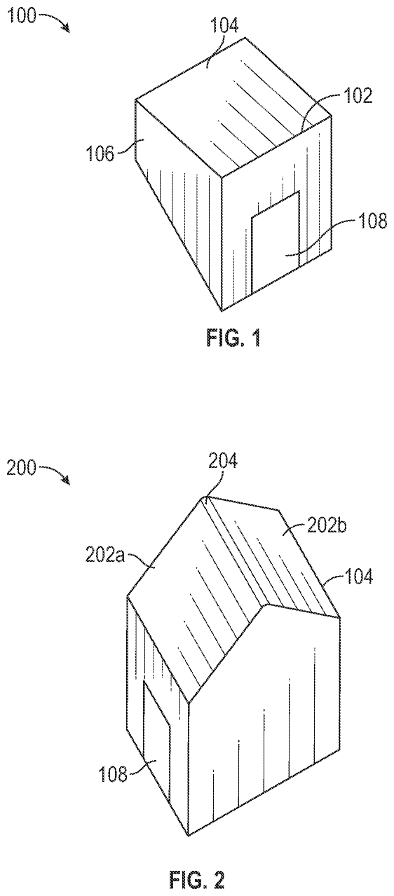

Referring to FIG. 1 is an example diagram 100 depicting a pet house with a single inclined rooftop, in accordance with one or more exemplary embodiments. The diagram 100 is a pet house and 102 depicts the space on which the roof top is installed, side walls 104, front side wall 106 which has entry/exit 108. The pet house floor may be elevated from the ground or placed on the ground with good insulation. In case of flat inclined roof a single heating radiating roofing element is fixed. In all cases these roof on the top of space 102 panels rest on the walls of pet house and extended beyond the walls more so at eaves.

Referring to FIG. 2 is another example diagram 200 depicting a pet house having two roof tops with a ridge piece in the centre, in accordance with one or more exemplary embodiments. The diagram 200 includes the pet house 200 having 202a and 202b as places where two roof top heating panels can be placed with a ridge piece 204 in the centre, and the entry/exit 108. In all cases these two roof top panels 202a and 202b rest on the walls of the pet house and extended beyond the walls more so at eaves.

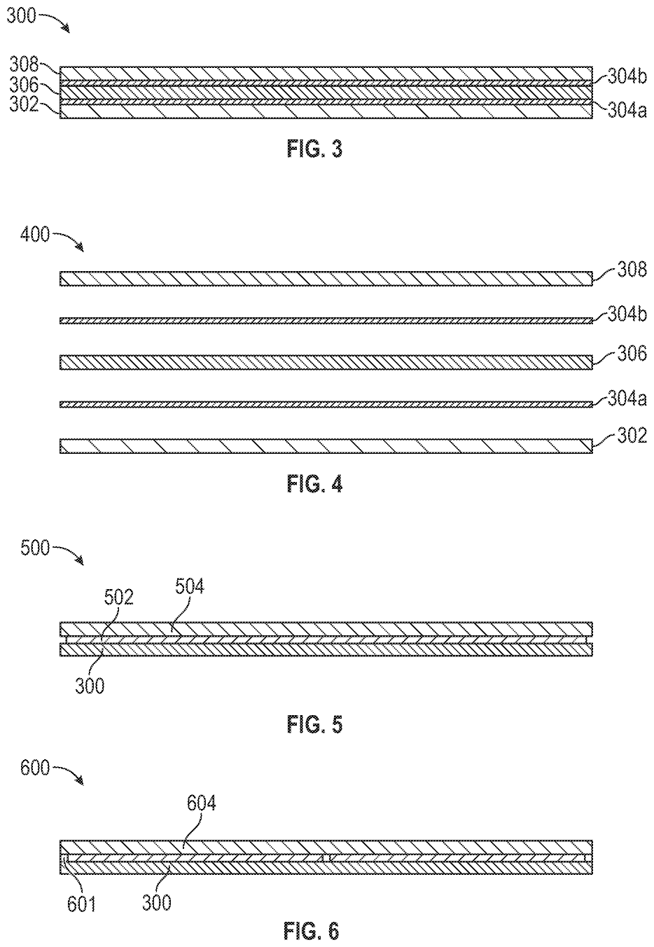

Referring to FIG. 3 is a diagram 300 depicting a typical construction of the encapsulated heating element, in accordance with one or more exemplary embodiments. The diagram 300 includes a bottom sheet 302, a resin-impregnated electrical resistance sheets 304a and 304b, an insulated heating element 306, and a top sheet 308. The encapsulated heating element 300 may include, but not limited into a roofing element, a building element and so forth.

The bottom sheet 302 is used as an interior facing of the pet house 102. The resin-impregnated electrical resistance sheets 304a and 304b may have good impact-resistant properties. The insulated heating element 306 may be sandwiched between the resin-impregnated electrical resistance sheets 304a and 304b and further sandwiched between building materials 302 and 308. The building panels may be incombustible and non-ignitable and are provided with a safety thermal cut out that limits the temperature of the panel.

The insulated heating element 306 may withstand high impulse voltage sandwiched between the resin impregnated electrical resistance sheets 304a and 304b. The non-metallic sheets may include, but not limited to calcium silicate building boards and so forth.

Referring to FIG. 4 is a diagram 400 depicting an exploded view of the encapsulated heating element as mentioned in FIG. 3, in accordance with one or more exemplary embodiments.

Referring to FIG. 5 is a diagram 500 depicting the addition of a rigid thermal insulation sheet and a weathering sheet on top of the thermal insulation in accordance with one or more exemplary embodiments. The diagram 500 includes a thermal insulation sheet 502, a weathering sheet 504, and the encapsulated heating element 300. The thermal insulation sheet 502 is configured to prevent heat from escaping into the atmosphere. The user may able to fix any desired weathering sheet 504 on the top of thermal insulation sheet 502.

Referring to FIG. 6 is another example diagram 600 depicting the encapsulated heating element on which a grid is placed that contains soft thermal insulating blankets 502 and weathering sheet 504 placed on the grid, in accordance with one or more exemplary embodiments.

Entire assembly shown in FIG. 5 and FIG. 6 may be the roof of required length and width to suit specified pet house with the electric outlet under the building panel connected to a thermostat to control the temperature in the pet house and other optional features such as control programmed timer, and pet sensing devices can be added as required.

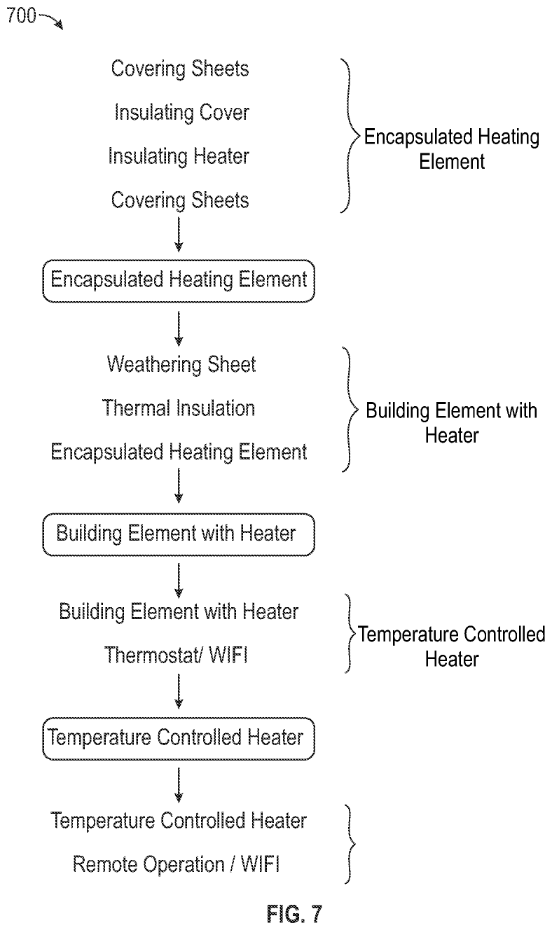

Referring to FIG. 7 is a flowchart 700 depicting an exemplary method to integrate heating system into building elements of the pet house, in accordance with one or more exemplary embodiments. As an option, the method 700 is carried out in the context of the details of FIG. 1, FIG. 2, FIG. 3, FIG. 4, FIG. 5 and FIG. 6. However, the method 700 is carried out in any desired environment. Further, the aforementioned definitions are equally applied to the description below.

In an exemplary method to integrate heating system into building elements of the pet house comprising, providing building panels with an encapsulated heating element, embedding into the building element thus concealed and configured to emit radiant heat into a pet house, protecting building panels with a safety thermal cutout to limit the temperature of the building panels, providing a thermostat to the building panels to control the temperature inside the pet house.

Reference through this specification to “one embodiment”, an embodiment, or similar language means that a particular feature, structure or characteristic described in connection with the embodiment is included in at least one embodiment of the present disclosure. Thus, appearance of the pharses “in one embodiment”, in an embodiment” and similar language throughout this specification may, but do not necessarily, all refer to the same embodiment.

Although the present disclosure has been described in terms of certain preferred embodiments and illustrations thereof, other embodiments and modifications to preferred embodiments may be possible that are within the principles of the invention. The above description and figures are therefore to be regarded as illustrative and not restrictive.

Thus the scope of the present disclosure is defined by the appended claims and includes both combinations and sub combinations of the various features described herein above as well as variations and modifications thereof, which would occur to persons skilled in the art upon reading the foregoing description.

We claim:

1. A roofing system of a pet house, comprising:
a heat source built into a roofing element and an insulated heating element of specified heat output encapsulated into insulating and covering sheets to form an encapsulated heater embedded panel;
a thermal insulation material on top of such panel to prevent escape of heat into atmosphere and a thermal cutout to limit the temperature of the said building element so as to limit the maximum temperature of the heating element; and
a weathering sheet on top of the thermal insulation to form the building element.

2. The system as claimed in claim 1, wherein a thermostat is used to control temperature inside the pet house.

3. The system as claimed in claim 1, wherein the building sheets that can be incombustible and non-ignitable are used such as Calcium Silicate or Fibre cement sheets.

4. The system as claimed in claim 1, wherein desired operation system can be added such as remote operational system with programmable timers or operation through a phone using WIFI.
